(19) United States
(12) Patent Application Publication
(10) Pub. No.: US 2006/0274835 A1
(43) Pub. Date: Dec. 7, 2006

(54) METHOD AND APPARATUS FOR CODING INFORMATION

(76) Inventors: Eric Hamilton, Los Gatos, CA (US); Carl Page, San Francisco, CA (US); Alexey Dolgoborodov, St. Petersburg (RU); Anton Tikhonov, St. Petersburg (RU); Vladimir Semenyuk, St. Petersburg (RU)

Correspondence Address: GLENN PATENT GROUP, 3475 EDISON WAY, SUITE L, MENLO PARK, CA, 94025, US

(21) Appl. No.: 11/458,374

(22) Filed: Jul. 18, 2006

Related U.S. Application Data
(62) Division of application No. 10/574,159.
(60) Provisional application No. 60/507,185, filed on Sep. 29, 2003.

(51) Int. Cl. H04N 11/02; H04N 11/04; H04N 7/12; H04B 1/66

(52) U.S. Cl. 375/240.25

(57) ABSTRACT

The invention provides a method and apparatus for coding information that is specifically adapted for smaller presentation formats, such as in a hand held video player. The invention addresses, inter alia, reducing the complexity of video decoding, implementation of an MP3 decoder using fixed point arithmetic, fast YcbCr to RGB conversion, encapsulation of a video stream and an MP3 audio stream into an AVI file, storing menu navigation and DVD subpicture information on a memory card, synchronization of audio and video streams, encryption of keys that are used for decryption of multimedia data, and very user interface (Ul) adaptations for a hand held video player that implements the improved coding invention herein disclosed.

### CROSS REFERENCE TO RELATED APPLICATIONS

This application is a divisional of U.S. patent application Ser. No. 10/574,159 filed Sep. 29, 2004, which claims priority from PCT Patent Application Serial No. PCT/US04/32296 filed Sep. 29, 2004, which claims priority from U.S. Provisional Application No. 60/507,185 filed Sep. 29, 2003, all of which are incorporated herein in their entirety by this reference thereto.

### BACKGROUND OF THE INVENTION

1. Technical Field

The invention relates to information storage and presentation. More particularly, the invention relates to a method and apparatus for coding information.

2. Description of the Prior Art

Video coding techniques are well known. For example, the Motion Picture Experts Group (MPEG) has established various video coding standards, e.g. MPE2 and MPEG4. MPEG4 is a robust standard that supports large presentation formats and complex audio encoding, which traits are beneficial, for example in a home theater environment. Such standards are widely accepted because they provide faithful reproduction of source material for such critical applications as home theater presentations, but they have shortcomings for other applications. For example, such standards are not well suited for inexpensive, hand held video players, where the presentation format and form factor of the device do not require the fidelity of these standards, nor do they justify the expense attendant with implementing such standards.

It would be advantageous to provide a method and apparatus for coding information that is specifically adapted for smaller presentation formats, such as in a hand held video player.

### SUMMARY OF THE INVENTION

The invention provides a method and apparatus for coding information that is specifically adapted for smaller presentation formats, such as in a hand held video player. The invention addresses, inter alia, reducing the complexity of video decoding, implementation of an MP3 decoder using fixed point arithmetic, fast YcbCr to RGB conversion, encapsulation of a video stream and an MP3 audio stream into an AVI file, storing menu navigation and DVD subpicture information on a memory card, synchronization of audio and video streams, encryption of keys that are used for decryption of multimedia data, and very user interface (Ul) adaptations for a hand held video player that implements the improved coding invention herein disclosed.

### BRIEF DESCRIPTION OF THE DRAWINGS

FIG. 1 is a plan view of a handheld video player according to a presently preferred embodiment of the invention;

FIG. 2 is a display illustration of device icons according to the invention;

FIG. 3 is a block schematic diagram of an HHE™ video encoder according to the invention;

FIG. 4 is a flow diagram that illustrates content protection for prerecorded content according to the invention; and

FIG. 5 is a flow diagram that illustrates for content protection for downloadable content according to the invention.

### DETAILED DESCRIPTION OF THE INVENTION

The invention herein is an apparatus and method for coding information that is particularly well suited for, but not limited to, such devices as hand held video players. The disclosure herein first discusses an exemplary player.

The Video Player

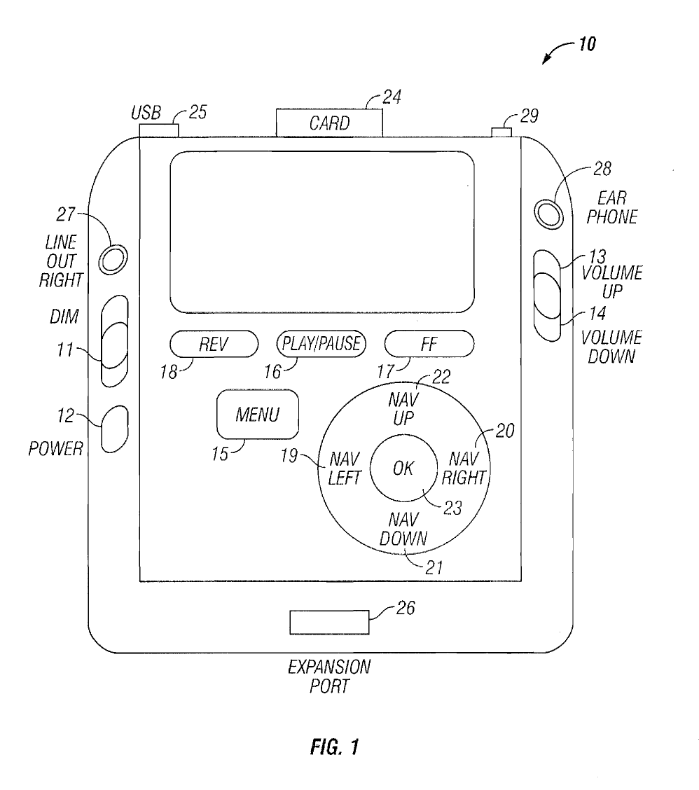

An exemplary handheld video player, the ZVUE!™ player sold by HandHeld Entertainment of San Francisco, Calif., in which the preferred embodiment of the invention, referred to as HHE™ video encoding, may be practiced is first discussed. FIG. 1 is a plan view of a handheld video player 10 according to a presently preferred embodiment of the invention.

Controls

The player has fifteen buttons:
DIM, BRIGHT 11,
POWER 12,
VOL-UP 13,
VOL-DOWN, 14
MENU 15,
PLAY/PAUSE 16,
FF 17,
REV 18,
NAV-LEFT 19,
NAV-RIGHT 20,
NAV-DOWN 21
NAV-UP 22,
NAV-OK 23, and
CARD 24.

The player also includes various ports, such as a USB port 25, an expansion port 26; and includes connections for line out 27, earphones 28, and power 29.

There are a number of player states. The player processes button push/release events, and some other hardware events. The player response to an event depends on its state.

The Basics

Menu navigation

The NAV-* keys control the selection of a menu item. On [NAV-OK] transition is made to menu item selected. In general, [MENU] takes the user to the previous menu. If the user is in a FAT file hierarchy it takes the user to the previous directory. If the selected item is playable, such as an HHE Video or a directory full of MP3 audio, then the [PLAY] button plays it from the start.

Volume and brightness control

Volume control range: −73 . . . +6 dB

Volume control granularity: 1 dB

Volume level display timeout: 5 seconds

Volume level display: horizontal bar at the bottom of the screen

After Power Off/ Power On, the audio level is to previous the value unless it is off, in which case it is set to low volume. The Brightness is set to brightest.

Pressing the audio level control button in any player state results in current level being displayed in the bottom of the screen. Subsequent pressures on volume buttons change audio level by 1 dB. After volume control buttons are untouched for two seconds, the volume level bar disappears.

Brightness control

DIM and BRIGHT move the player up and down through at least Five brightness settings.

No visual indicator is on screen except for actual screen brightness change. At the dimmest setting, the display is Off. This is useful for conserving batteries when only audio is desired. In this case, software should do less video work. At Display Off, any brightness input is displayed.

Note: If display is off while audio is playing, the volume indicator appears on the screen when the Volume rocker button is pressed for the sake of consistency, and user convenience.

Menu or Navigation buttons that present a UI turn the screen on. The screen goes off again when in the normal playback mode.

Visual Feedback

Graphic thermometer sliders are superimposed on moving video to give feedback for volume and brightness. Compressed bitmaps are included for UI elements, icons, and menu screens. The format for icons include a transparent color.

A simple animation language may also be provided. For example, this could be an HHE format AVI, an Animated GIF (subject to IP check), or a FLASH animation.

Audible Feedback

There is a characteristic ZVUE! startup sound. Audible button feedback has two styles. Click for commands executed. A thud sounds for buttons pressed out of context.

Ports

USB

The player responds to a connected USB port by displaying a USB connection icon and is unresponsive to buttons aside from power, which can be used to turn it on or off.

SD Card

Upon insertion, called button [CARD] the player goes to the state “Media Insertion” and starts playing.

States

Off

The initial state for the player is “OFF”, that is everything is down. The only way to get from this state is by pressing the [POWER] button or by inserting a media card [CARD].

ZVUE! Welcome Screen

After a momentary two-second display of the ZVUE! welcome graphic and distinctive ZVUE! startup sound, the player returns to the next expected operation.

Powering ON

On “POWER pushed” event, the ZVUE! Welcome Screen is temporarily displayed. If media is present, this is followed by the Media menu. Else, this is followed by the Player Menu.

Media Insertion

The ZVUE! Welcome Screen is temporarily displayed. On “Card inserted” event, the player checks the card type. The system goes to Firmware Update Approval if it is an update card; it goes to Application Approval from the card if there is an application; and it goes to Media Menu Temporary if it is a media card.

Media Menu Temporary

The Media Menu is displayed, offering a chance to navigate to other options. After a Timeout of six seconds, the media starts playing unless other media menu controls were used. If buttons are pressed, the Timeout changes to “After 3 minutes, go OFF.”

Player Menu

The user is asked to insert a card, or to choose an item from the menu. The menu is:
Screen savers (disabled)
Settings (includes text color and style and settings associated with mp3 and jpeg playback)
Resume (If the player was powered OFF or paused part way through the same media that is still inserted, a resume option appears.)

Timeout: 60 seconds transition to OFF.

Media Menu

Check the media type. In the case that a writable SD or MMC card is found to contain both HHE media and other formats, go to state “Media Choice Menu”.

Timeout: 60 seconds transition to OFF.

Media menu is a short animation (may be empty), followed by a menu background picture with menu items displayed. The first menu item is active. All menu items point to video chapters. After a period of inactivity, the menu animation restarts. The [menu] button from media menu starts Player Menu (see above).

If the media contains more than one track, the first one is selected and this is visually apparent. Pressing [Play] starts that media playing. The [REV] and [FF] buttons change the selected feature. Navigation buttons allow moving around the UI.

Playing HHE

When HHE AVI media cards are present, the play function is started. This is the state in which the user spends the most time and to which the user is most attentive.

Power

Goes to “Off.” If the media is longer than five minutes, the position it was playing at is stored.

MENU goes to the “MediaMenu”

PLAY goes to “Playing HHE-Pause”

FF, Fast Forward feature of “Playing HHE” state

REV, Skip back feature of “Playing HHE” state

NAV-LEFT, Previous Video “Chapter”

NAV-RIGHT, Next Video “Chapter”

NAV-UP, Slow Motion feature enabled or disabled.

NAV-OK, Sound continues, but Playing menu on screen. Goes to state “Playing HHE-MENU”

The NAV-DOWN button enables the AB REPEAT feature, and can be called the AB Repeat button during playback.

The following is the AB/REpeat state table. These states are sub-states of Playing HHE.
PLAYING
Shows the video normally. Moves to the next track when done.
Pressing A/B repeat moves it to state Playing-A at that position.
Playing-A
When the video auto-repeats, it restarts at point A instead of the start.
Pressing A/B repeat moves it to state Playing-AB at that position.
Playing-AB
When the video auto-repeats, it restarts at point A instead of the start and go to point B instead of the end. It continues to repeat from point A to B until the A-B Timeout is reached.
Pressing A/B repeat moves it to state Playing-Autorepeat.
TIMEOUT—The A-B repeat feature goes to PLAYING after 60 minutes of playing.
   Playing HHE-Pause

This state is reached when the [PLAY] key is pressed when in state Playing HHE. The user is viewing a still frame from the video.
[PLAY] resumes from pause
[REV] goes to the beginning of the chapter, does not resume from the pause.
[FF] audio off, video playback is 2× (approx.)
[MENU] goes to the “MediaMenu”
[NAV-LEFT], Previous Video Frame or Keyframe or chapter, depending on implementation difficulty. Remain in state Playing HHE-Pause.
[NAV-RIGHT], Next Video Frame and remain in state Playing HHE-Pause.
[NAV-UP], Repeat or Slow Motion features enabled or disabled.
[NAV-OK], Puts Playing info on screen. Changes the display to show a bar graph that indicates the time offset into the video track and the name of the track. Remains in state Playing HHE-Pause.
[NAV-DOWN] sets the AB REPEAT point in the video, and advances the AB Repeat state exactly as it would in state Playing HHE.
   Playing HHE-FF

Sound is off. Video is playing approximately twice normal speed.
[PLAY] audio on, normal speed
[REV] same as PLAY
[FF] Audio off, video at six times normal speed. Player does it by skipping B and, if necessary, P frames. This can result in the loss of continuity. Remains in state Playing HHE-FF. If [FF] is pressed again it toggles to twice FF.
   Media Choice Menu

A jpg viewer is also provided for displaying digital photos. It is possible to combine content HHE downloads with other MP3 and JPEG content. Only in that case is this navigation state necessary. It is basically a FAT file system navigator.

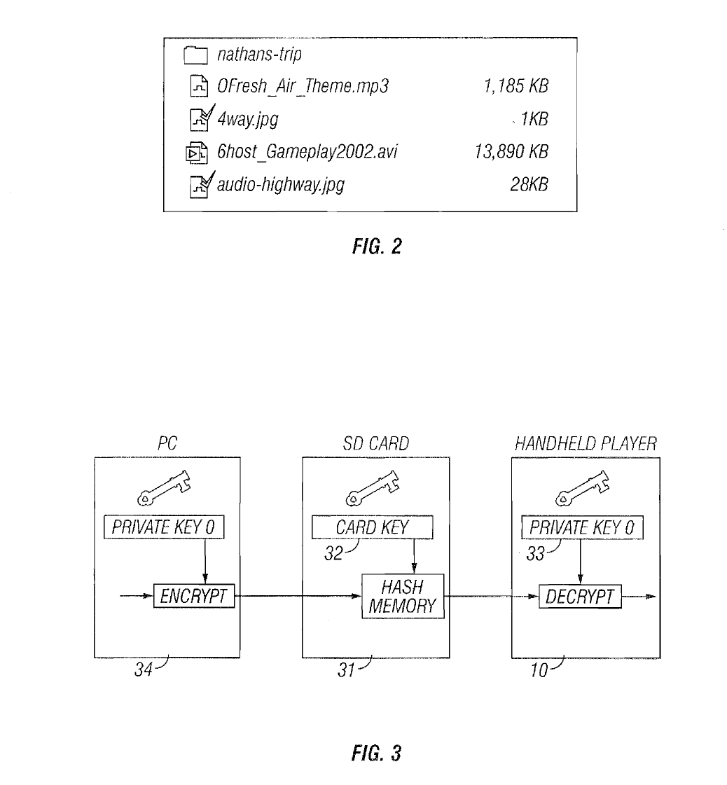

Displays a list of things on the card. Tiny icons are used in the left column to describe several types of object. Icons are similar to the tiniest icons in windows (see FIG. 2).
Folders
HHE Videos
Audio
Pictures
Text files

Displays options as available on the card.

Upon selected Video [NAV-OK] (takes user to the media menu for that content.)

Upon selected JPEG [NAV-OK] takes user to the Slide Show viewer starting with that picture.

Upon selected Music [NAV-OK] starts music playing at that file. Navigates folders of MP3 files—see the discussion of state “MP3 Player.”

Slide Show Menu

Software prepares two play lists. The Audio Playlist, and the Photo Playlist. If a play list file is on the card it may use that to determine the order of audio and video files. Otherwise, both play lists are in breadth-first recursive order through the folders with the files sorted in the most natural order possible.

[play] takes user to state Slide Show Playing.

Slide Show Playing

The [REV.] [play] [FF] buttons affect the music playback.

The direction keys effect the photo selection.

[Right] and [Left] go to previous and next picture.

[MENU] brings up the slideshow menu.”

[NAV-OK] brings up the “slide menu.”

Slide Menu

Displays the current slide. If possible it displays the whole slide, then zooms in slightly.

The [REV] [PLAY] [FF] buttons affect the music playback.

Operation of the four direction keys affects the photo position, panning the photo in the chosen direction until the edge is reached where it stops, making a thud sound.

[menu] zooms out more. If totally zoomed out, it offers “Slide Show Playing” options.

[NAV-OK] zooms in more. If totally zoomed in, it offers “Slide Menu Detail.”

Timeout: go to next slide in the sequence after adjustable time determined in settings,

Slide Menu Detail

Offers the following choices by text or icon.
SlideShow Delay (amount of time before slide advance)
Rotate picture
Gamma Adjust
Special Effects
Crop here
Choose animation
Choose soundtrack
   JPEG Viewer

When there are no MP3 's the player behaves as above, except with no music

MP3 Player

Menu structure shows one directory of the FAT file system. Only folders with usable content are shown.

Overview of the HHe Codec Multimedia Format

The HHe Compression/Decompression (“Codec”) multimedia format is a format for holding highly compressed digital video, audio, graphics, and navigation data.

A file which conforms to the HHe format normally carries the extension “.hhe.” It is a complex file comprised of one or more different sub-files. The sub-file types which are supported by the Hhe format are:
config: the main configuration file for the media that specifies the media, the main navigation script file name, the decoding engine to use (a custom decoding engine can reside on the media, the default one resides in internal memory).
avi: multiplexed compressed video/audio streams.
bmp: menu subpictures that are MS Windows sixteen-color compressed bitmaps.
nav: navigation scripts for video chapters which specify the order in which chapters are played.
mnu: menu files, that describe menu representation and functionality by specifying subpictures for menu items, pointers to chapters, etc.

One or more of the sub-file types listed above may be present in a HHe file. The only requirement is that there must some auditory or visual content present (an avi or bmp sub-file).

The format of each sub-file depends on its function. For detailed specifications of the file format, please refer to the discussion herein entitled “HHe file format specification.”

HHe Compression Technology

The HHe format supports full-motion video and can display up to 24-bits of color per pixel on a full-color screen. HHe compresses video content at variable bit rates up to 100:1, and it decompresses the same content at real-time speeds using minimal system resources on low-cost, low-power processors, such as the Motorola Dragonball™ i.MXL (manufactured by Motorola, Inc. of Schaumburg, Ill.), which is used in the ZVUE! video player.

The HHe video compression technology is a proprietary algorithm that was developed specifically to produce superior compression performance yet maintain reasonable complexity in decompression. The compression scheme employs motion estimation followed by transform coding, as shown in the block diagram of FIG. 3. At a top level the HHe algorithm is similar to video compression standards developed over the past decade, but the specific techniques chosen ensure real-time decoder implementations on mobile devices.

The HHe format supports audio compression at various quality levels from low bitrate mono through near CD quality stereo. The HHe format uses the popular MP3 audio compression standard as the default audio format. The HHe format also supports additional audio formats such as WMA and AAC.

Security Features of the HHe Format

The security and integrity of compressed content is extremely high with the HHe format due to the encryption scheme and other features employed.

Multimedia encoded in the HHe format is protected from unauthorized copying using a highly secure encryption scheme. The encryption algorithm, based on the Blowfish algorithm, is a symmetric private key algorithm using 128-bit keys. Blowfish is a symmetric block cipher that can be used as a drop-in replacement for DES or IDEA. It takes a variable-length key, from 32 bits to 448 bits, making it ideal for both domestic and exportable use. Blowfish was designed in 1993 by Bruce Schneier as a fast, free alternative to existing encryption algorithms. Since then it has been analyzed considerably, and it is slowly gaining acceptance as a strong encryption algorithm. Blowfish is unpatented and license-free, and is available free for all uses. The original Blowfish paper was presented at the First Fast Software Encryption workshop in Cambridge, UK (proceedings published by Springer-Verlag, Lecture Notes in Computer Science #809, 1994) and the April 1994 issue of Dr. Dobb's Journal.

Eight different keys have been generated using a particularly strong random number generator, scrambled, and stored at various offsets within the ZVUE! internal memory. Different keys are used to encrypt prerecorded content, downloaded content, and code updates.

Content Protection for Prerecorded Content

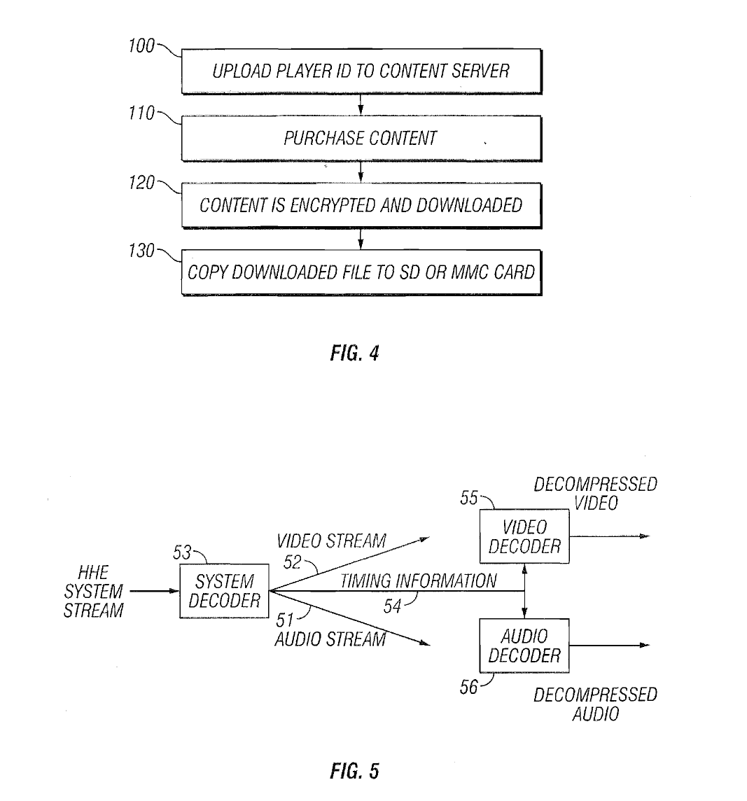

FIG. 4 illustrates the process for content protection of prerecorded content. Prerecorded content is stored on SD or MMC memory cards 31. These memory cards contain a unique card key 32 which is stored in a protected area of the card. A player key 33, key 0, stored within the ZVUE! internal memory is modified by the unique card key and data are encrypted with this new key prior to being stored in the memory card. Data cannot be copied onto another memory card and played back without knowledge of player key 0, the card key, and the encryption algorithm employed.

Content Protection for Downloadable Content

FIG. 5 illustrates content protection for downloadable content. Downloaded content is encrypted with a separate player key, key 1, modified by a unique Player ID. Therefore downloaded content can only be decrypted and played back by one particular player. The client must upload the Player ID to the content server 100 (34; FIG. 3) prior to purchasing 110 and downloading content 120. After downloading the data are copied onto an SD or MMC memory card 130. Data cannot be copied onto another memory card and played back on a different player without knowledge of player key 1, the new player ID, and the encryption algorithm employed.

Timeout of Prerecorded or Downloaded Content

The player has a real-time clock which can be set through the user interface. The real-time clock can be used to reject content which has a limited lifetime. For example, promotional content can be downloaded for free and played back for a limited time period; when it has expired the promotional content no longer can be played unless the user purchases it.

HHE Audio/Video Synchronization

HHE Audio/Video (AV) synchronization is implemented as follows:
Each decompressed video frame is assigned a unique id (0,1,2,3, . . . ).
Each audio packet (containing 1152 audio samples) is also assigned a unique id (0,1,2,3. . . ).
The AV sync code monitors the ids of the latest rendered video frame and audio packet.
Every time a video interrupt occurs, these ids are recalculated into real time stamps.
The AV sync code compares these time stamps and determine whether next video frame must be repeated (shown twice) or dropped (skipped).
The audio stream is never adjusted. That means only video frames can be skipped or repeated to fit current audio position.

Specifically the procedure which takes place at each video interrupt is:

```
video_time_stamp = just_rendered_video_frame_id /
video_frames_per_second (Value of
video_frames_per_second comes from AVI header)
audio_time_stamp = latest_audio_id /
audio_packets_per_second (Value of
audio_packets_per_second is normally 44100/1152 =
38.28125 (samples_per_sec/samples_per_packet))
difference = audio_time_stamp − video_time_stamp
if (difference > +one_frame_duration_time)
    skip next video frame
else if (difference < −one_frame_duration_time)
    repeat current video frame
```

ZVUE! File Formats

The file format for storing ZVUE! media comes from the way the navigation system, the graphics system, and the decoding engines are designed. It is assumed that media containing video/audio streams is organized in chapters, associated with navigation scripts and can optionally carry a custom decoding engine.

The media should be FAT 16-formatted, and the content organized in files. All data are stored in the root folder, other folders are ignored if present.

Files on the Media Are:

“config” main configuration file for the media that specifies the media type (currently only two types are supported; ZVUE!-VIDEO and FIRMWARE), the main navigation script file name, the decoding engine to use (a custom one can go on the media, the default one resides in a flash)
“* .nav” navigation scripts for video chapters
“*.avi” video/audio streams
“*.mnu” menu files, that describe menu representation and functionality by specifying subpictures for menu items, pointers to chapters, etc.
“*.bmp” menu subpictures that are MS Windows 16-color compressed bitmaps. Colors {0,0,0} and {255,255,255} are reserved for transparent.
   File Types That are not Supported but Can be Added Later:
“*.mp3” audio only streams
“*.jpg”,“*.jpeg” jpeg images (for browsing digital photos from SD card, or to use as menu background etc.).
   Configuration File

This is a plain text ASCII file in either Windows (CR/LF) or UNIX (CR) format:
A semicolon ‘;’ starts line comment
Commands are : <key>=<value>. Spaces are allowed. If value contains spaces, it is enclosed in double quiets (“”)
Empty lines are ignored

Some keys may not be defined. The default semantics are applied in this case (see Table 1 below).

TABLE 1
Default Key Semantics

| Key | Value | Defaults |
|---|---|---|
| application | Filename of the executable | Use internal decoder |
| | to use as a decoder | from the flash |
| start | Filename of main menu | Runs first *.nav file |
| | navigation script (the | found on the media |
| | navigation script that is run | |
| | first) | |
| type | Media content type | ZVUE!-VIDEO |
| encryption_key | Encrypted checksum to | — |
| | verify the firmware | |
| version | Firmware version | 0 |

Type=ZVUE!_VIDEO

Notifies the boot loader that this card stores video content. If Application tag is present, the boot loader loads it to memory and runs there. If not, the boot loader loads application from the flash.

Type=MP3

Notifies the boot loader that this card stores mp3 tracks. If Application tag is present, the boot loader loads it to memory and runs there. If not, the boot loader loads application from the flash. The application runs as a standard MP3 player.

Type=PHOTO

Notifies the boot loader that this card stores JPEG images. If Application tag is present, the boot loader loads it to memory and runs there. If not, the boot loader loads application from the flash. The application runs in slide-show mode.

Type=FIRMWARE Notifies the boot loader that this card stores new media driver. The loader checks zveu.axf file from the card with encrypted checksum encryption_key and then burns it to the flash. It also checks the version against current and notifies user if it is older.

AVI File

The video player uses standard Windows AVI format for streaming the videos. The file should contain one video stream, coded with HHE video encoder (FOURCC=HHE0), and/or one audio stream, coded with any MP3 driver (wFormatTag=0x0055). When using B-frames, they should be put into separate AVI chunks. Typically, it requires some post processing because the VFW drivers usually are not capable of producing it. The audio bitstream format complies with ISO CD 11172-3 document.

Navigation Script File

Navigation scripts specify the semantics of player buttons for the specific chapter, the AVI stream and subpictures to use and the actions to perform. The navigation script is a test file, with navigation commands represented on separate lines. Commands are case-sensitive.

Commands are : <key>=<value>. Spaces are allowed. If value contains spaces, it should be enclosed in double quiets (“ ”)

Command set:
stream=<avi-file>
   Specifies an AVI file associated with this script.
next=<scriptname>
   Specifies a chapter that runs after this one is ended.
previous=<scriptname>
   Specifies a chapter to start on REW.

A semicolon at first position starts line comment.

If it is the first chapter in a chain, previous should not be present.

If it is the last chapter in a chain, next should not be present.

Menu File

Menu file is a text file that specifies the menu appearance and functionality.

Commands should start at the beginning of each line, command arguments follow on the same line, any number of white space characters (‘,’ ‘\t’) can be used as a separator. Menu contains a background image (stored in AVI), a number of static bitmaps over the background and a number of menu items associated with video chapters. Command arguments are either filenames or numbers, filenames should be put in double quotes. All arguments are obligatory.

A semicolon at first position starts line comment.

Command set:
parent menu active_item
   Specifies parent menu (menu) and number of item (active_item) that should be active when we come to this menu from current menu
background avi-file
   Specifies an AVI (usually of one frame) that contains menu background, The AVI file is played on the screen, and the last frame of that AVI is used as a background for menu.
static bitmap x y transparency
   Specifies a static bitmap displayed over the background image. x, y specify the bitmap offset from the top left corner; transparency is a number from 0 to 255 that specifies the transparency (0 means transparent, 255 means solid).
item bitmap_0 x y transparency bitmap_{—}1 x y transparency navig_script menu active_item
   Specifies menu item. bitmap_0 is displayed for a selected item, bitmap_1 is displayed for deselected ones, x, y and transparency following a bitmap name specify its position and transparency. navig_script specifies the script to start when this menu item is executed, if “”, this means a submenu should be run, specified in menu argument. menu sets new menu for the script to run, or a submenu to run, if script name is not specified. If it is “ ”, current menu is used. active_item specifies number of active item in a new menu or submenu.
      HHE AVI Files

The AVI file is a container for any number of data streams of any kind. The main parts of AVI file are:
1. The main AVI header. It always contains a stamp (“RIFF”) and overall file size (for streaming). It also describes general info on the file, such as a number of streams stored in it, streams data sizes, whether the file contains an index, offset at which data streams begin, etc.
2. An optional index can be present in the AVI file. It contains an entry for each data chunk (see below) describing its type and position in the file. The index is located at the very end of the file, after the data streams.
3. Each data stream format is described by its own stream header. Video stream header is actually BITMAPINFOHEADER structure (width, height, bits per pixel, compression type (HHE0 or HHE1)). Audio stream header is actually WAVEFORMATEX structure (audio format (MP3 ), number of channels, samples per second).
4. After all the headers, data streams begin. Data are organized in chunks. Each chunk belongs to a stream and contains a header and actual data.
The header contains the stream number this chunk belongs to (usually 01—video, 00—audio), stream type code (“dc”—compressed video, “wb”—compressed audio), and chunk's size in bytes.

Therefore, the overall layout of data is as follows:

01wb<chunk1 size> <- header
....chunk 1 data... <- data
00dc<chunk2 size>
....chunk2 data...
01wb<chunk3 size>
....chunk3 data...
00dc<chunk4 size>
....chunk4 data
etc...

MPEG4 Complexity Reduction Solutions

To reduce the complexity of MPEG4 decoding the following four solutions have been introduced:
Disabling of intra prediction of AC coefficients
   Intra prediction of AC coefficients is not made. The flag that indicates the need for AC prediction has been eliminated from the bitstream.
Disabling of motion compensation rounding control
   Rounding control is disabled. Constant additions are used during averaging: 0 for averaging of two values and 1 for averaging of four values. The rounding bit has been eliminated from the bitstream.
Combination of VLC decoding and dequantization in one step
   Dequantization of the coefficient is made right after decoding of its variable length code. Speed-up is possible due to exclusion of zero coefficients from dequantization process.
Simplification of inverse discrete cosine transformation with the use of significance map
   Significance map is used to store the positions of last nonzero coefficients in each row/column of discrete cosine transformation block. Significance map is filled during VLC decoding. Knowing the number of last nonzero coefficient in row/column it is possible to simplify the inverse discrete cosine transformation for this particular row/column. Two different versions of inverse discrete cosine transformation are provided: one—for rows/columns of 8 coefficients and one for rows/columns of 3 coefficients. Note, that when all coefficients in row/column are zero coefficients, inverse transformation should not be made at all.
      Description of Fast “YUV to RGB555” Conversion

To speed-up the color conversion routine, a conversion table is used. The table index is calculated as a function of three colors in YUV format:

Index = ((U >> (8-BITS_U)) << (BITS_Y+BITS_V)) +
((V >> (8-BITS_V)) << ( BITS_V)) + (Y
>> (8-BITS_Y))

where Y, U and V are 8-bit color components in YUV format; and BITS_Y, BITS_U. BITS_V are the numbers of significant bits for each color: Y, U, and V.

The number of indexes is (1<<(BITS_Y+BITS_U+BITS_V)). The conversion table cell represents color in RGB555 format that corresponds to color in YUV format. The size of the cell is two bytes (high-order bit is unused). Therefore, the size of the table is the number of indexes *2, that is:
(1<<(BITS_Y+BITS_U+BITS_V+1)).

The number of significant bits for Y color component must be greater than number of significant bits for U and V components, because Y color component contains more useful information for human visual perception. Currently the following significant numbers are used:
BITS_Y=7
BITS_U=5
BITS_V=5

The color conversion table is organized in the manner that can help to avoid cache misses during conversion of image in YUV 4:2:0 format. In YUV 4:2:0 format for each chrominance pixel there are four luminance pixels. A fact that index depends on Y component less than on U and V components makes data cache misses infrequent.

There can be other types of data chunks rather than video and audio. For example, if video color format is eight bits per pixel or less, then a special palette chunk can present. Note that two video chunks never go one by one. There is always one audio chunk between them (even of zero size). Each video chunk contains one compressed video frame exactly (see below on this, regarding b-frames). Each audio chunk contains either two or three audio packets (each packet is 1152 samples, when decompressed).

B-Frames

When compressing with b-frames, the invention breaks the rule that each video frame is stored in its own chunk. It stores several video frames in one chunk. The currently preferred embodiment of the invention inserts large amounts of empty (zero length) video chunks in the stream to isolate audio chunks. So the overall layout of data streams is as follows:

<audio chunk>
<big video chunk, containing 4 frames I-P-B-B>
<audio chunk>
<empty video chunk>
<audio chunk>
<empty video chunk>
<audio chunk>
<empty video chunk>
...

This actually wastes a lot of space because even an empty chunk contains a header and is contained in the index. This is a limitation of Video for Windows drivers. It is possible to eliminate this by applying a post-processing utility to an AVI file that isolates each video frame in its own chunk and drops all the empty chunks.

Fast Fixed-Point Implementation of MPEG-1 Layer 3 Decoding Algorithm

General Remarks on Operations With Fractional Values for Fixed Point Arithmetic

To represent data in fixed point operations, we use the following transformation:
u=Fix(u_{float})=(int)(u_{float}*(2>>nBitsFraction)+0.5), (1.1)
where nBitsFraction is the number of bits for fractional part, value 0.5 is used for rounding.

The following values of nBitsfraction are used:
24 for signal samples (representation 32.24),
24 or 15 for constant coefficients (representation 32.24 or 32.15).

Let
y_{float}=x_{float}*c_{float},
where x_{float}c_{float}, are some variables (c_{float} is usually a constant).

Then, in the case of 32.24 data representation,
x=(int)(x_{float}* (2>>24)+0.5)
c=(int)(c_{float}* (2>>24)+0.5),
y=(x*c)>>24.

Because we use 32-bit integer operations, it is necessary to avoid overflow in calculation of product x*c.

For this purpose, we represent data as a sum of high and low parts:
u=uLow+(uHigh<<12),
where
uhigh+>>12,
uLow=u−(uHigh<<1.2)=U & 0x00000FFF
Thus, we have
y=(x*c)>>24=(xLow+(xHigh<<12))*(cLow+(cHigh<<12))>>24

This expression can be rewritten as
xHigh*cHigh+((xLow*cHigh+cLow*xHigh)>>12)+((xLow*cLow)>>24)

To speed up the multiplication, we can remove small parts from this sum. In our implementation, we distinguish three different levels of precision, any of them can be chosen at compile time. The simplifications used for multiply operation in each mode are as follows:

For high precision
y=xHigh*cHigh+((xLow*cHigh+cLow*xHigh)>>12) (1.2)

For medium and low precision:
y=xHigh*cHigh+((xLow*cHigh)>>12) (1.3)

For 32.12 representation of constant coefficients,
c=(int)(C_{float}*(1<<12)+0.5)

The simplified multiplication on constant coefficients in 32.24 representation can be implemented as
y=((x>>6)*c)>>6, (1.4)
in assumption that
|c_{float}|<1
If
1.0<|c_{float}|<2.0,
the multiplication is performed as
y=((x>>6) *c)>>5 (1.5)
where
c=(int)(c_{float}*(1<<12)+0.5),

In a similar way, if
1.0<|c_{float}|<(1<<g)
it is possible to use approximate multiplication in a form
y=((x>>6) *c)>>(6−q) (1.6)
Then
c=(int)(c_{float}* (1<<(12−q) )+0.5),
Computational Speedupd of Inverse Modified Discrete Cosinie Transform (IMDCT)

To speed-up IMDCT calculation, the simplified multiplication by transform coefficients is used.

Case IDMCT on 36 and 12 Points

The transform coefficients, with absolute values smaller than 1, are represented in 32.15 format. For multiplication by this coefficients, formula (1.4) is used. For coefficients with absolute values greater than 1, formula (1.6) is used.

Case IDMCT on 64 Points (Synthesis Function)

All transform coefficients have absolute value smaller than 1, and represented in 32.15 format. For this case, formula (1.4) is used.

Note: In high precision mode, the more precise formula (1.2) is used for all IDMCT functions.

Computational Speedup for Final Windowing Operation.

To generate one output sound sample in 16 bit PCM format, it is necessary to calculate convolution of samples from delay line with window coefficients. For float data representation, the convolution loop appears as

```
    for(sum=0, j=0; j<16; j++)
    sum  +=
WindowTable[i+32*j]*line[(pos+j*64+i+(j&1)*32)&1023];
    (3.1)
```

where WindowTable [512] is array of window coefficients, pos is a current position in the delay line, i is a number of output samples in block of 32 samples.

The speed up is achieved by calculation of output samples in following ways:

Scaled Transposed Window Table is Used:
WindowTableST[n]=Fix(WindowTable[i+32*j])>>q;
   where Fix( ) corresponds (1.1) with nBitsFraction=24, n=i+32* j, for each i=0 . . . 31 index j=0 . . . 15, which provides consecutive access to array elements. Because factors of a window with indexes j=7, 8 can have absolute value greater than 1, the value q is obey to the rule:
if j=7 or j=8, q=9, else q=8
   Optimization of a Convolution Loop

The convolution loop is a sequence of operators of the form
sum+=line[(r+g)&1023])*(*Pn_WindowTableST++))>>m;
where
Pn_WindowTableST is a pointer to the scaled transposed window table,
   r=pos+i, and
   g=j*64+(j&1)*32.

To provide true multiplication result, we use m=6 for j=7, 8, else m=7.

Reduced Window Table for Low Precision Mode

In (3.1), some of the items with number j=0, 1, 2 and j=12, 13, 14, 15 are eliminated from calculation due to their small impact to the result (because of small window coefficients).

For High Precision

Sixteen groups of window table items for each index i are normalized and have an exponent value, which is constant value inside group. Then, the convolution loop is organized in sequence of the operators of the form
S[j]=line[(r+g)&1023])*(*Pn_WindowTableST++))>>7;

The final summation is made with shifts, which depend on values of exponents.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A real-time video decoder for use with a mobile device, comprising:
means for receiving a system stream, said system stream comprising:
a system layer containing timing and other information needed to demultiplex audio and video streams and to synchronize audio and video during playback; and
a compression layer comprising said audio and video streams;
a system decoder for extracting timing information from a system stream and sending said timing information to a other system components, said system decoder also demultiplexing said video and audio streams from said system stream and then sending each of said video and audio streams to a corresponding decoder;
a video decoder for decompressing said video stream; and
an audio decoder for decompressing said audio stream.

2. The decoder of claim 1, wherein the MP3 audio compression standard is used as a default audio format.

3. The decoder of claim 1, further comprising:
a decryption facility comprising of a decryption algorithm based on the Blowfish algorithm.

4. In a decoding technique, an audio/video (AV) synchronization method, comprising the steps of:
assigning each decompressed video frame in a video stream a unique id (0,1,2,3 . . . );
assigning each audio packet in an audio stream a unique id (0,1,2,3 . . . );
using an AV sync code to monitor the ids of a latest rendered video frame and audio packet;
recalculating said ids into real time stamps very time a video interrupt occurs; and
using said AV sync code to compare said time stamps and determine whether a next video frame must be repeated or dropped;
wherein said audio stream is never adjusted; and
wherein video frames are either skipped or repeated to fit a current audio position.
